(19) United States
(12) Patent Application Publication
(10) Pub. No.: US 2025/0230750 A1
(43) Pub. Date: Jul. 17, 2025

(54) BLADE VIBRATION MITIGATION OF INTEGRALLY BLADED ROTOR BY DAMPING ON DISK

(71) Applicant: RTX Corporation, Farmington, CT (US)

(72) Inventors: Yan Chen, South Windsor, CT (US); Zaffir A. Chaudhry, Portland, CT (US)

(73) Assignee: RTX Corporation, Farmington, CT (US)

(21) Appl. No.: 19/098,295

(22) Filed: Apr. 2, 2025

Related U.S. Application Data
(63) Continuation-in-part of application No. 17/502,277, filed on Oct. 15, 2021.

(51) Int. Cl. F01D 5/10

(52) U.S. Cl. CPC F01D 5/10; F05D 2230/90; F05D 2260/96; F05D 2300/611

(57) ABSTRACT

A vibration mitigation coating for an integrally bladed rotor including a disk including an interior radius hub proximate to an axis and an exterior radius flange distal from the axis, blades originating from the exterior radius flange portion of the disk, the blades extend from the exterior radius flange at an exterior radius flange outer face; the disk including a substrate with an external surface, the external surface extends from the interior radius hub to the exterior radius flange and along the exterior radius flange outer face; and a damping material disposed directly onto the external surface of the substrate, the damping material is located radially between the interior radius hub and the exterior radius flange and along the exterior radius flange outer face and between the blades.

This application claims priority to U.S. application Ser. No. 17/502,277 filed Oct. 15, 2021.

### BACKGROUND

The present disclosure is directed to mitigation of blade vibration of an integrally bladed rotor (IBR). Particularly, coating the disk of the IBR with a damping material having a thickness, shape and location configured to optimize damping on a specific frequency range.

The integrally bladed rotor shows advantages of decreasing drag and increasing efficiency of air compression of the gas turbine engine. Vibration localizations and concentration is a common phenomenon in IBR's, which poses high risk to induce excessive blade vibration. This issue becomes more pronounced for the IBR, which has lower damping compared to conventional fir-tree type bladed rotor. The high-frequency blade vibration leads to blade high cycle fatigue and causes severe engine damage.

Blade to blade interaction is the root cause of the vibration localization and concentration. The disk serves as the media and path to store and transfer vibratory energy between blades. However, it is very hard to implement any direct vibration mitigation mechanism on the blade itself. A damper ring is a prior technique used to mitigate the vibration of rotating structures. However, the damper ring damping effect is limited due to its size and energy dissipation mechanism. The damper ring is a separate ring that is inserted between two fixed walls of the disk and is not a coating onto the surface of the disk.

What is needed is a coating that can suppress the disk vibration by damping the vibration.

### SUMMARY

In accordance with the present disclosure, there is provided a vibration mitigation coating for an integrally bladed rotor comprising a disk including an interior radius hub proximate to an axis and an exterior radius flange distal from the axis, blades originating from the exterior radius flange portion of the disk, the blades extend from the exterior radius flange at an exterior radius flange outer face; the disk including a substrate with an external surface, the external surface extends from the interior radius hub to the exterior radius flange and along the exterior radius flange outer face; and a damping material disposed directly onto the external surface of the substrate, the damping material is located radially between the interior radius hub and the exterior radius flange and along the exterior radius flange outer face and between the blades.

A further embodiment of any of the foregoing embodiments may additionally and/or alternatively include the damping material is located at a radial location across the exterior radius flange and exterior radius flange outer face.

A further embodiment of any of the foregoing embodiments may additionally and/or alternatively include the damping material comprises a width dimension ¼ of the exterior radius to ⅛ of the exterior radius.

A further embodiment of any of the foregoing embodiments may additionally and/or alternatively include the damping material comprises a first damping material disposed on the external surface and a second damping material disposed on the first damping material.

A further embodiment of any of the foregoing embodiments may additionally and/or alternatively include the damping material comprises a cross section shape configured to mitigate a predetermined frequency.

A further embodiment of any of the foregoing embodiments may additionally and/or alternatively include the damping material comprises a predetermined shape responsive to a frequency range targeted to be dampened and material properties of the damping material.

A further embodiment of any of the foregoing embodiments may additionally and/or alternatively include the damping material is selected from the group consisting of a viscoelastic material, a super-elastic memory alloy and combinations thereof.

A further embodiment of any of the foregoing embodiments may additionally and/or alternatively include wherein the damping material comprises a thickness dimension with a range from about 10 mils to about 50 mils.

A further embodiment of any of the foregoing embodiments may additionally and/or alternatively include the damping material is located at a radial location of from ⅔ the exterior radius up to the exterior radius of the disk.

A further embodiment of any of the foregoing embodiments may additionally and/or alternatively include wherein the damping material is located on opposite sides of disk.

In accordance with the present disclosure, there is provided a process of vibration mitigation through coating an integrally bladed rotor comprising providing a disk including an interior radius hub proximate to an axis and an exterior radius flange distal from the axis, blades originating from the exterior radius flange portion of the disk, the blades extend from the exterior radius flange at an exterior radius flange outer face; the disk including a substrate with an external surface, the external surface extends from the interior radius hub to the exterior radius flange and along the exterior radius flange outer face; and disposing a damping material directly onto the external surface of the substrate, the damping material is located radially between the interior radius hub and the exterior radius flange and along the exterior radius flange outer face and between the blades.

A further embodiment of any of the foregoing embodiments may additionally and/or alternatively include the process further comprising locating the damping material at a radial location across the exterior radius flange and exterior radius flange outer face.

A further embodiment of any of the foregoing embodiments may additionally and/or alternatively include the process further comprising disposing the damping material at a width dimension ¼ of the exterior radius to ⅛ of the exterior radius.

A further embodiment of any of the foregoing embodiments may additionally and/or alternatively include the process further comprising disposing a first damping material on the external surface; and disposing a second damping material on the first damping material.

A further embodiment of any of the foregoing embodiments may additionally and/or alternatively include the process further comprising disposing the damping material with a cross section shape configured to mitigate a predetermined frequency.

A further embodiment of any of the foregoing embodiments may additionally and/or alternatively include the process further comprising disposing the damping material in a predetermined shape responsive to a frequency range targeted to be dampened and material properties of the damping material.

A further embodiment of any of the foregoing embodiments may additionally and/or alternatively include the damping material is selected from the group consisting of a viscoelastic material, a super-elastic memory alloy and combinations thereof.

A further embodiment of any of the foregoing embodiments may additionally and/or alternatively include the process further comprising disposing the damping material with a thickness dimension having a range from about 10 mils to about 50 mils.

A further embodiment of any of the foregoing embodiments may additionally and/or alternatively include the process further comprising disposing the damping material is located at a radial location of from ⅔ the exterior radius up to the exterior radius of the disk.

A further embodiment of any of the foregoing embodiments may additionally and/or alternatively include the process further comprising disposing the damping material on opposite sides of disk.

Other details of the damping material coating are set forth in the following detailed description and the accompanying drawings wherein like reference numerals depict like elements.

### BRIEF DESCRIPTION OF THE DRAWINGS

FIG. 1 is a schematic longitudinal sectional view of a turbofan engine.

FIG. 2 illustrates a perspective view of an exemplary integrally bladed rotor with damping material coating in accordance with various embodiments.

FIG. 3 illustrates a perspective view of an exemplary integrally bladed rotor with damping material coating in accordance with various embodiments.

FIG. 4 illustrates a cross-section of an exemplary integrally bladed rotor disk with damping material coating in accordance with various embodiments.

### DETAILED DESCRIPTION

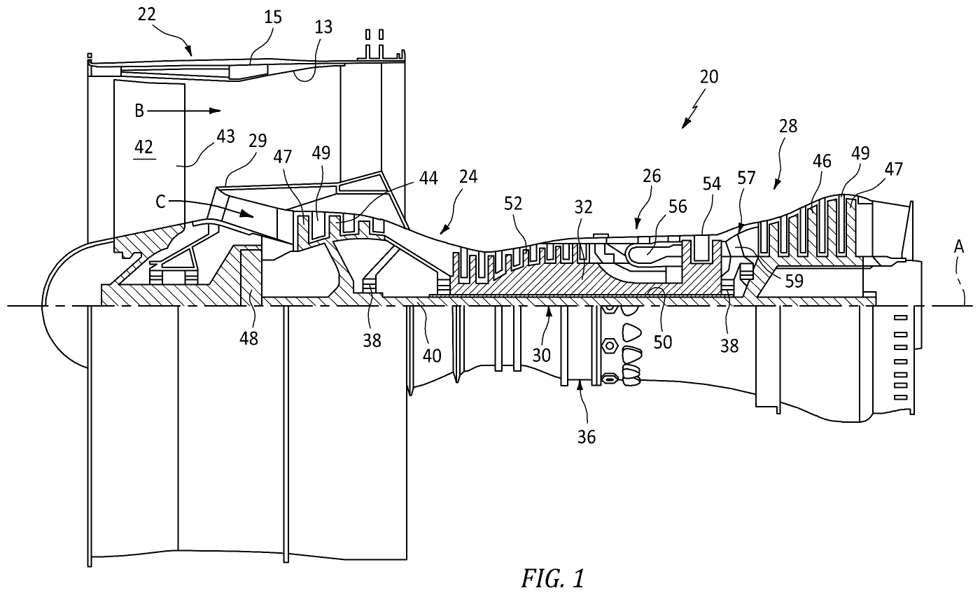

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of static vanes adjacent the rotatable airfoils. The rotatable airfoils and vanes are schematically indicated at 47 and 49.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft. (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. The engine parameters described above, and those in the next paragraph are measured at this condition unless otherwise specified.

“Low fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The low fan pressure ratio is a span-wise average of the pressure ratios measured across the fan blade 43 alone over radial positions corresponding to the distance. The low fan pressure ratio can be less than or equal to 1.45, or more narrowly greater than or equal to 1.25, such as between 1.30 and 1.40. “Low corrected fan tip speed” is the actual fan tip speed in feet/second divided by an industry standard temperature correction of [(Tram ° R)/(518.7° R)]^{0.5}. The “low corrected fan tip speed” can be less than or equal to 1150.0 feet/second (350.5 meters/second), and greater than or equal to 1000.0 feet/second (304.8 meters/second).

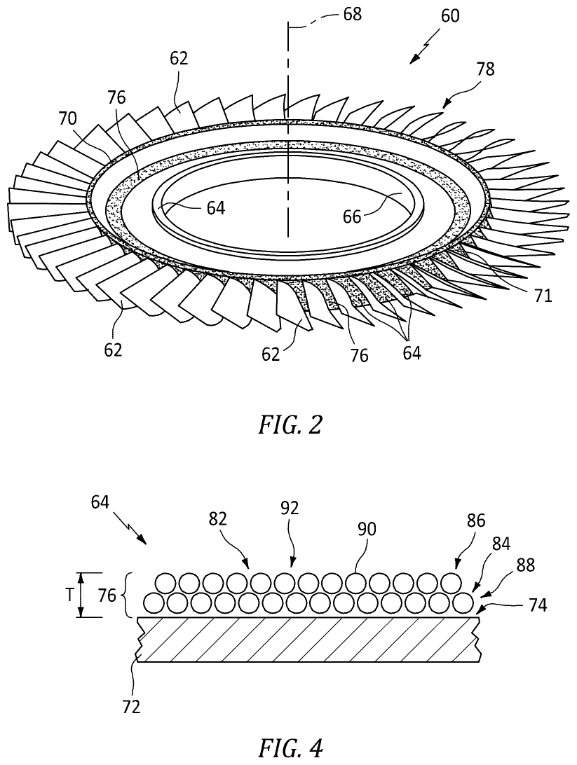

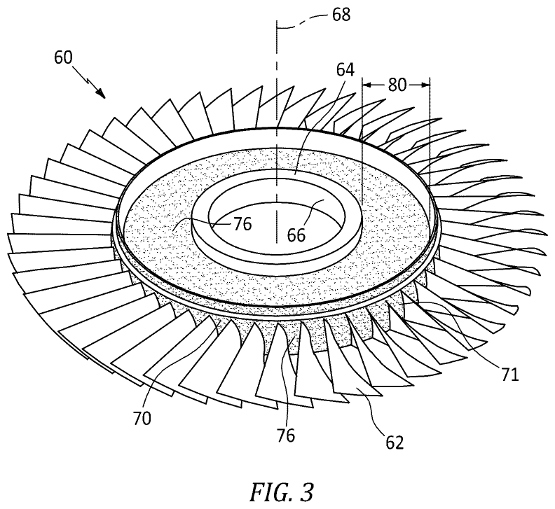

Referring also to FIG. 2 and FIG. 3, a rotor 60 can be of any variety of rotor, with an exemplary embodiment being an integrally bladed rotor (IBR). IBRs 60 are formed of a unitary or monolithic construction, wherein the radially projecting rotor blades 62 are integrally formed with the central hub or simply disk 64. Although the present disclosure will focus on a rotor 60 that is an IBR, it is to be understood that the presently described configuration could be equally applied to other types of rotor such as impellors (i.e. centrifugal compressors) which may or may not be IBRs, to IBR fans, or to other rotors used in the gas turbine engine 20.

Referring also to FIG. 4, the disk 64 can include an interior radius hub 66 that is nearest an axis 68, and an exterior radius flange 70 that is radially distal from the axis 68. The blades 62 originate from the exterior radius flange 70 portion of the disk 64. Particularly, the blades 62 extend from the exterior radius flange 70 at an exterior radius flange outer face 71. The disk 64 includes a substrate 72 with an external surface 74. The external surface 74 extends radially from the interior radius hub 66 outward to the exterior radius flange 70 and extends across the exterior radius flange outer face 71.

A damping material 76 can be disposed directly onto the external surface 74 of the substrate 72. The damping material 76 can be disposed directly onto the external surface 74 of the substrate 72 in between the blades 62 on the exterior radius flange outer face 71. The damping material 76 can be coated having a thickness T. The thickness T can range from about 10 mils to about 50 mils (thousandth of an inch). In an exemplary embodiment the thickness T of the coating can be tailored to be a predetermined thickness of 50 mils depending on the specific frequency range that is targeted to be dampened. The predetermined thickness provides a technical advantage because it can provide more damping without compromising the structural integrity of the coating layer under high centrifugal force). In an exemplary embodiment, the damping material 76 can be deposited on both sides, (i.e., opposite sides) of disk 64.

The damping material 76 can be located radially between the interior radius hub 66 and the exterior radius flange 70. The radial location 78 can be tailored to be a predetermined radial location 78 depending on the specific frequency range that is targeted to be dampened and the material properties of the damping material 76. The damping material 76 coating the exterior surface 74 is shown to be proximate to the exterior radius flange 70 at FIG. 2 and proximate the exterior radius flange 70 at FIG. 3. The predetermined radial location 78 can range from ⅔ the exterior surface 74 up to the exterior radius flange 70 of the disk 64. The radial location 78 provides a technical advantage because the damping material 76 works more effectively when the damping material 76 is closest to the blades 62. Applying the damping material 76 to the exterior surface 74 effectively disrupts the energy flow between blades 62 which is the root cause of the energy localization to a few blades 62 which then potentially fail. The blades 62 extend from the exterior surface 74 adjacent the exterior radius flange outer face 71 of the turbine rotor 60. A path of energy flow between one blade 62 to another blade 62 thru the exterior radius flange outer face 71 can be disrupted by utilizing the damping material 76. The energy flow can be minimized and hence prevalent failures can be minimized and reduce the blade-to-blade interaction.

The damping material 76 can be coated in a width dimension 80 along the external surface 74. The width dimension 80 can be tailored to be a predetermined width dimension 80 depending on the specific frequency range that is targeted to be dampened and the material properties of the damping material 76. The damping material 76 coating the exterior surface 74 is shown to have a narrower width dimension at FIG. 2 and wider width dimension 80 at FIG. 3. In an exemplary embodiment, the width dimension 80 can be from about ¼ of the dimension from the axis 68 to the exterior radius flange 70 to about ⅛ of a dimension from the axis 68 to the exterior radius flange 70. The width dimension 80 provides a technical advantage because those width dimensions are a balance between the damping effect and the material to be deposited.

In an exemplary embodiment the damping material 76 can be coated in layers 82, for example a first layer 84 and a second layer 86. The first layer 84 can be composed of a first damping material 88. The second layer 86 can be composed of a second damping material 90. The materials can be tailored to meet a predetermined damping function depending on the specific frequency range that is targeted to be dampened and the material properties of the damping materials 88, 90. The damping materials 88, 90 provide a technical advantage because the damping materials 88, 90 have very high loss modulus at high temperature, which can dissipate vibratory energy effectively.

In an exemplary embodiment, the thickness T can be varied across the width 80 of the damping material 76 to create shaped cross-section 92. The cross-section shape 92 can be tailored to be a predetermined shape 92 depending on the specific frequency range that is targeted to be dampened and the material properties of the damping material 76. The shape 92 of the damping material 76 provides a technical advantage because the shape 92 can maximize the damping effect on target frequency ranges.

The damping material 76 can be a viscoelastic material, a super-elastic memory alloy and combinations thereof. The viscoelastic material can exhibit both elastic and viscous behavior when deformed. There are three main characteristics of viscoelastic materials, creep, stress relaxation, and hysteresis. The creep phenomenon is used to describe the continued deformation of a viscoelastic material after the load has reached a constant state. A superelastic alloy can belong to the larger family of shape-memory alloys. When mechanically loaded, a superelastic alloy deforms reversibly to very high strains (up to 10%) by the creation of a stress-induced phase. When the load is removed, the new phase becomes unstable, and the material regains its original shape.

The damping material 76 coating can be achieved through coating processes, such as plasma spraying, additive manufacturing and adhering preformed damping material 76 strip.

A technical advantage of the disclosed damping material coating includes a coating pattern—shape, thickness, location, and the like can be optimized to target on a specific frequency range.

A technical advantage of the disclosed damping material coating includes the capacity to prevent the high cycle fatigue caused by the blade vibration of IBR.

A technical advantage of the disclosed damping material coating includes overcoming the obstacle of a direct blade mitigation system by suppressing the disk vibration, such that the energy flow into the blade is suppressed.

There has been provided a damping material coating. While the damping material coating has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A vibration mitigation coating for an integrally bladed rotor comprising:
a disk including an interior radius hub proximate to an axis and an exterior radius flange distal from the axis, blades originating from the exterior radius flange portion of the disk, the blades extend from the exterior radius flange at an exterior radius flange outer face; the disk including a substrate with an external surface, the external surface extends from the interior radius hub to the exterior radius flange and along the exterior radius flange outer face; and
a damping material disposed directly onto the external surface of the substrate, the damping material is located radially between the interior radius hub and the exterior radius flange and along the exterior radius flange outer face and between the blades.

2. The vibration mitigation coating for an integrally bladed rotor according to claim 1, wherein the damping material is located at a radial location across the exterior radius flange and exterior radius flange outer face.

3. The vibration mitigation coating for an integrally bladed rotor according to claim 1, wherein the damping material comprises a width dimension ¼ of said exterior radius to ⅛ of the exterior radius.

4. The vibration mitigation coating for an integrally bladed rotor according to claim 1, wherein the damping material comprises a first damping material disposed on the external surface and a second damping material disposed on the first damping material.

5. The vibration mitigation coating for an integrally bladed rotor according to claim 1, wherein the damping material comprises a cross section shape configured to mitigate a high response at a predetermined frequency.

6. The vibration mitigation coating for an integrally bladed rotor according to claim 1, wherein the damping material comprises a predetermined shape responsive to a frequency range targeted to be dampened and material properties of the damping material.

7. The vibration mitigation coating for an integrally bladed rotor according to claim 1, wherein the damping material is selected from the group consisting of a viscoelastic material, a super-elastic memory alloy and combinations thereof.

8. The vibration mitigation coating for an integrally bladed rotor according to claim 1, wherein the damping material comprises a thickness dimension with a range from 10 mils to 50 mils.

9. The vibration mitigation coating for an integrally bladed rotor according to claim 1, wherein the damping material is located at a radial location of from ⅔ the exterior radius up to the exterior radius of the disk.

10. The vibration mitigation coating for an integrally bladed rotor according to claim 1, wherein the damping material is located on opposite sides of the disk.

11. A process of vibration mitigation through coating an integrally bladed rotor comprising:
providing a disk including an interior radius hub proximate to an axis and an exterior radius flange distal from the axis, blades originating from the exterior radius flange portion of the disk, the blades extend from the exterior radius flange at an exterior radius flange outer face; the disk including a substrate with an external surface, the external surface extends from the interior radius hub to the exterior radius flange and along the exterior radius flange outer face; and
disposing a damping material directly onto the external surface of the substrate, the damping material is located radially between the interior radius hub and the exterior radius flange and along the exterior radius flange outer face and between the blades.

12. The process of claim 11 further comprising:
locating the damping material at a radial location across the exterior radius flange and exterior radius flange outer face.

13. The process of claim 11 further comprising:
disposing the damping material at a width dimension ¼ of the exterior radius to ⅛ of the exterior radius.

14. The process of claim 11, wherein disposing the damping material further comprises:
disposing a first damping material on the external surface; and
disposing a second damping material on the first damping material.

15. The process of claim 11 further comprising:
disposing said damping material with a cross section shape configured to mitigate a predetermined frequency.

16. The process of claim 11 further comprising:
disposing said damping material in a predetermined shape responsive to a frequency range targeted to be dampened and material properties of the damping material.

17. The process of claim 11, wherein said damping material is selected from the group consisting of a viscoelastic material, a super-elastic memory alloy and combinations thereof.

18. The process of claim 11 further comprising:
disposing the damping material with a thickness dimension having a range from 10 mils to 50 mils.

19. The process of claim 11 further comprising:
disposing the damping material is located at a radial location of from ⅔ the exterior radius up to the exterior radius of the disk.

20. The process of claim 11 further comprising:
disposing the damping material on opposite sides of the disk.
